(19) United States
(12) Patent Application Publication
(10) Pub. No.: US 2011/0272841 A1
(43) Pub. Date: Nov. 10, 2011

(54) PLASTICITY PLASTIC FILM AND METHOD FOR APPLYING PLASTICITY PLASTIC FILM TO IN-MOLD DECORATION

(75) Inventors: HSIN YUAN CHEN, CHIAYI COUNTY (TW); YU-YUN HSIEH, TAIPEI COUNTY (TW); CHENG LUN LIAO, TAOYUAN COUNTY (TW)

(73) Assignee: ENTIRE TECHNOLOGY CO., LTD., TAOYUAN COUNTY (TW)

(21) Appl. No.: 12/940,333

(22) Filed: Nov. 5, 2010

(30) Foreign Application Priority Data
May 5, 2010 (TW) 99114390

(51) Int. Cl. C08L 63/00; C08F 120/10; C08L 33/06; C08K 3/36; C08K 3/22; B29C 45/14; C08L 75/04

(52) U.S. Cl. 264/101; 264/266; 525/330.3; 525/187; 525/131; 524/507; 524/502; 523/467; 523/457; 524/430

(57) ABSTRACT

A method for applying a plasticity plastic film to an in-mold decoration, including the steps of: (a) providing a substrate defining a top surface and a bottom surface, printing layer and a plastic material; wherein the plasticity plastic film comprises a photo-curing multiple functional group oligomer, a thermohardening resin and a cross-linking agent, and the photo-curing multiple functional group oligomer is cross-linked with the thermohardening resin through the cross-linking agent; (b) forming the plasticity plastic film on the top surface of the substrate; (c) hardening the plasticity plastic film; (d) solidifying the plasticity plastic film to form a plasticity resin layer; (e) covering the bottom surface of the substrate with the printing layer; (f) simultaneously pressing the plasticity resin layer and the substrate to form a predetermined shape; and then (g) forming the plastic material on a bottom surface of the printing layer.

### BACKGROUND OF THE INVENTION

1. Field of the Invention

The instant disclosure relates to a plastic film and a method for applying the plastic film to an in-mold decoration, and more particularly, to a control device and a plasticity plastic film and a method for applying the plasticity plastic film to an in-mold decoration (IMD).

2. Description of Related Art

The curing of coating systems carrying activated double bonds by radiation, such as e.g. UV light, IR radiation or electron beam radiation, is known and technically established. It is one of the fastest curing methods in coating technology. Adhesion is often a problem, however. In addition, the curing of coatings that can be cured by electromagnetic radiation is dependent on an adequate radiation dose. In badly lit or unlit areas, this leads to significantly poorer curing or to no cross-linking at all.

Binders based on polyisocyanates and polyols are extremely suitable for producing high-quality coatings. The desired paint properties, such as e.g. adhesion, elasticity, chemical resistance, weathering resistance or scratch resistance, can be adjusted within broad limits by varying the feed materials.

Combining these two mutually independent curing mechanisms in one binder system allows their positive properties to be united. Such systems, known as “dual cure” systems, are known. For example, U.S. Pat. No. 4,342,793 describes the use of coating systems compounded from a radiation-curable reactive thinner, e.g. acrylic acid esters, a polyol and a polyisocyanate. The problem here is that in unlit areas the radiation-curable reactive thinner is left behind as a plasticiser and thus has a negative influence on the film properties or can even leave the film, which can lead to undesirable physiological effects.

Also known are “dual cure” binders whose radiation-curable components are chemically bonded to the polyisocyanate, so that the described effects can be avoided. For example, European patent application EP-A 0 928 800 teaches the use of NCO-functional urethane acrylates containing isocyanurate groups as a component of a “dual cure” coating system. In order to be able to apply these coating compounds easily, adequately low viscosities are needed, so various organic solvents are used.

Due the ecological and economic requirements for modern paint systems to use as little organic solvent as possible, if any, to lower the viscosity, there is a desire to use low-viscosity paint resins. Polyisocyanates having an allophanate structure have long been known for this purpose, as described inter alia in European patent EP-A 0 682 012.

A plastic film formed by above-mentioned manufacturing method of the prior art can be applied to an in-mold decoration. The method of applying the plastic film to the in-mold decoration according to the prior art approximately includes: coating (step 1), forming (step 2) and solidifying (step 3), and the step 2 and step 3 needs to execute at two different places. Hence, when the half-finished product (the step 2 has been finished already) of the plastic film needs to transport from one place to another place, a shield member needs to shade the half-finished product of the plastic film to prevent the half-finished product of the plastic film from being solidified by light.

### SUMMARY OF THE INVENTION

One particular aspect of the instant disclosure is to provide a plasticity plastic film and a method for applying the plasticity plastic film to an in-mold decoration. After the plasticity plastic film has been formed and solidified, the plasticity plastic film still can be formed as a predetermined shape by subsequent processing.

To achieve the above-mentioned advantages, the instant disclosure provides a plasticity plastic film, including a photo-curing multiple functional group oligomer, a thermohardening resin and a cross-linking agent. The photo-curing multiple functional group oligomer is represented by the following chemical formula:

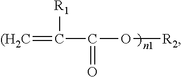

n1≧3, wherein R₁ is one of hydrogen (H) and alkyl (CH₃), and R₂ is one of alkyl, polyurethane, polyester, acrylate and epoxy resin.

Moreover, the thermohardening resin is a chain type structure that is composed of a polyalcohol and an isocyanate, and the thermohardening resin is represented by the following chemical formula: —(—CONH—R—NHCO—O—R—O—)ₙ₂— n2≧1 and R1 is alkyl.

Furthermore, the cross-linking agent is composed of a double-bond acrylic functional group structure and a hydroxyl group structure, and the cross-linking agent is represented by the following chemical formula:

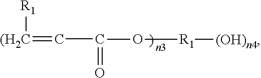

2≦n3+n4, 1≦n3 and 1≦n4.

In addition, the photo-curing multiple functional group oligomer occupies 20%˜70% of the plasticity plastic film by weight, the thermohardening resin occupies 40%˜70% of the plasticity plastic film by weight, the cross-linking agent occupies 10%˜40% of the plasticity plastic film by weight, the double-bond acrylic functional group structure connects with the photo-curing multiple functional group oligomer, and the hydroxyl group structure connects with thermohardening resin.

To achieve the above-mentioned advantages, the instant disclosure provides a plasticity plastic film, including a photo-curing multiple functional group oligomer, a thermohardening resin and a cross-linking agent. The photo-curing multiple functional group oligomer is represented by the following chemical formula:

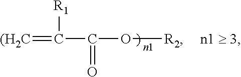

wherein R₁ is one of hydrogen (H) and alkyl (CH₃), and R₂ is one of alkyl, polyurethane, polyester, acrylate and epoxy resin.

Moreover, the thermohardening resin is a chain type structure that is composed of a polyalcohol and an isocyanate, and the thermohardening resin is represented by the following chemical formula: —(—CONH—R—NHCO—O—R—O—)ₙ₂—, n2≧1 and R1 is alkyl.

Furthermore, the cross-linking agent composed of a double-bond acrylic functional group structure and an isocyanate group structure, and the cross-linking agent is represented by the following chemical formula:

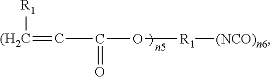

2≦n5+n6, 1≦n5 and 1≦n6;

In addition, the photo-curing multiple functional group oligomer occupies 20%˜70% of the plasticity plastic film by weight, the thermohardening resin occupies 40%˜70% of the plasticity plastic film by weight, the cross-linking agent occupies 10%˜40% of the plasticity plastic film by weight, the double-bond acrylic functional group structure connects with the photo-curing multiple functional group oligomer, and the isocyanate group structure connects with thermohardening resin.

To achieve the above-mentioned advantages, the instant disclosure provides a method for applying a plasticity plastic film to an in-mold decoration, including the steps of: (a) providing a substrate defining a top surface and a bottom surface, printing layer and a plastic material; wherein the plasticity plastic film comprises a photo-curing multiple functional group oligomer, a thermohardening resin and a cross-linking agent, and the photo-curing multiple functional group oligomer is cross-linked with the thermohardening resin through the cross-linking agent; (b) forming the plasticity plastic film on the top surface of the substrate; (c) hardening the plasticity plastic film; (d) solidifying the plasticity plastic film to form a plasticity resin layer; (e) covering the bottom surface of the substrate with the printing layer; (f) simultaneously pressing the plasticity resin layer and the substrate to form a predetermined shape; and then (g) forming the plastic material on a bottom surface of the printing layer.

Therefore, after the plasticity plastic film has been formed and solidified, the plasticity plastic film still has a certain plasticity. Hence, the plasticity plastic film still can be formed as a predetermined shape by subsequent processing after solidifying the plasticity plastic film.

To further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention that they be used for limiting the instant disclosure.

### BRIEF DESCRIPTION OF THE DRAWINGS

FIG. 1 shows a flowchart of the method for applying a plasticity plastic film to an in-mold decoration according to the instant disclosure; and

FIG. 2 shows a schematic view of the method for applying a plasticity plastic film to an in-mold decoration from step (A) to (G) according to the instant disclosure.

### DETAILED DESCRIPTION OF THE PREFERRED EMBODIMENTS

The first embodiment of the instant disclosure provides a plasticity plastic film, including: a photo-curing multiple functional group oligomer (such as UV photo-curing multiple functional group oligomer), a thermohardening resin (such as thermohardening oligomer with high extensibility) and a cross-linking agent.

With regard to the photo-curing multiple functional group oligomer, the photo-curing multiple functional group oligomer may be represented by the following chemical formula:

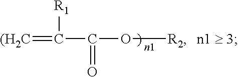

If R₁ is hydrogen (H), the photo-curing multiple functional group oligomer may be an acrylic resin. If R₁ is alkyl (CH₃), the photo-curing multiple functional group oligomer may be a methacrylic resin. Hence, R₁ may be one of hydrogen (H) and alkyl (CH₃). In addition, R₂ may be one of alkyl, polyurethane, polyester, acrylate and epoxy resin. When the number of n1 is large, the reaction locations for light-curing process are more, thus the crosslink density is high to obtain high hardness, wear performance and chemical resistance etc. Of course, when the number of n1 is larger, the following forming process would be difficult.

With regard to the thermohardening resin, the thermohardening resin may be a chain type structure that is composed of a polyalcohol and an isocyanate. For example, the polyalcohol and the isocyanate (such as diisocyanate) are polymerized to form a chain type polyurethane (PU) resin. In addition, the thermohardening resin may be represented by the following chemical formula: —(—CONH—R—NHCO—O—R—O—)ₙ₂—, n2≧1 and R1 may be alkyl.

With regard to the cross-linking agent, the cross-linking agent includes a heat-curing functional group structure and a photo-curing functional group structure for cross-linking the photo-curing multiple functional group oligomer and the thermohardening resin. For example, the cross-linking agent may be composed of a double-bond acrylic functional group structure and a hydroxyl group structure, thus the double-bond acrylic functional group structure connects with the photo-curing multiple functional group oligomer, and the hydroxyl group structure connects with thermohardening resin. In other words, the photo-curing multiple functional group oligomer and the thermohardening resin can be cross-linked together through the cross-linking agent. In addition, the cross-linking agent may be represented by the following chemical formula:

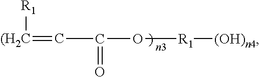

2≦n3+n4, 1≦n3 and 1≦n4.

Moreover, the first embodiment of the instant disclosure discloses experimental data as shown in the following <Table 1>, the photo-curing multiple functional group oligomer may occupy 20%˜70% of the plasticity plastic film by weight, the thermohardening resin may occupy 40%˜70% of the plasticity plastic film by weight, the cross-linking agent may occupy 10%˜40% of the plasticity plastic film by weight.

In addition, the composition of the plasticity plastic film in the first embodiment may further includes a LTV-curing multiple functional group reaction monomer, an organic-inorganic nano hybrid material, inorganic nano particles, an initiator and an additive etc. according to different requirements.

The organic-inorganic nano hybrid material may include a nano SiO₂ and a nano Al₂O₃, and the organic-inorganic nano hybrid material may occupy 0.1%˜30% of the plasticity plastic film by weight (the better weight percentage is between 1%˜20% and the best weight percentage is between 5%˜10%) as shown in the following <Table 1>. However, the definitions for the weight percentage of the organic-inorganic nano hybrid material are just examples and do not limit the instant disclosure.

The inorganic nano particles comprises nano SiO₂ powders and nano Al₂O₃ powders, and the inorganic nano particles occupy 0.1%˜30% of the plasticity plastic film by weight (the better weight percentage is between 1%˜20% and the best weight percentage is between 5%˜10%) as shown in the following <Table 1>. However, the definitions for the weight percentage of the organic-inorganic nano hybrid material are just examples and do not limit the instant disclosure.

The second embodiment of the instant disclosure provides a plasticity plastic film, including: a photo-curing multiple functional group oligomer (such as UV photo-curing multiple functional group oligomer), a thermohardening resin (such as thermohardening oligomer with high extensibility) and a cross-linking agent.

With regard to the photo-curing multiple functional group oligomer, the photo-curing multiple functional group oligomer may be represented by the following chemical formula:

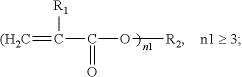

R₁ may be one of H (acrylic resin) or CH₃ (methacrylic resin), R₂ may be one of alkyl, polyurethane, polyester, acrylate and epoxy resin, and R₁ further includes alkyl.

With regard to the thermohardening resin, the thermohardening resin may be a chain type structure that is composed of a polyalcohol and an isocyanate. For example, the polyalcohol and the isocyanate (such as diisocyanate) are polymerized to form a chain type polyurethane (PU) resin. In addition, the thermohardening resin may be represented by the following chemical formula: —(—CONH—R—NHCO—O—R—O—)ₙ₂—, n2≧1 and R1 may be alkyl.

With regard to the cross-linking agent, the cross-linking agent includes a heat-curing functional group structure and a photo-curing functional group structure for cross-linking the photo-curing multiple functional group oligomer and the thermohardening resin. For example, the cross-linking agent may be composed of a double-bond acrylic functional group structure and an isocyanate group structure, thus the double-bond acrylic functional group structure connects with the photo-curing multiple functional group oligomer, and the isocyanate group structure connects with thermohardening resin.

In other words, the photo-curing multiple functional group oligomer and the thermohardening resin can be cross-linked together through the cross-linking agent. In addition, the cross-linking agent may be represented by the following chemical formula:

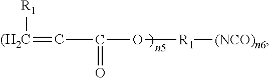

2≦n5+n6, 1≦n5 and 1≦n6.

Moreover, the same as the first embodiment, the second embodiment of the instant disclosure discloses experimental data as shown in the following <Table 1>, the photo-curing multiple functional group oligomer may occupy 20%˜70% of the plasticity plastic film by weight, the thermohardening resin may occupy 40%˜70% of the plasticity plastic film by weight, the cross-linking agent may occupy 10%˜40% of the plasticity plastic film by weight.

In addition, the composition of the plasticity plastic film in the second embodiment may further includes a UV-curing multiple functional group reaction monomer, an organic-inorganic nano hybrid material, inorganic nano particles, an initiator and an additive etc. according to different requirements.

Hence, the difference between the second embodiment and the first embodiment is that: the hydroxyl group structure in the first embodiment can be replaced by the isocyanate group structure in the second embodiment. Therefore, the instant disclosure not only can cross-link the photo-curing multiple functional group oligomer and the thermohardening resin together, but also the plasticity plastic film can be applied to the in-mold decoration at the same place and without using any shade member to shade the plasticity plastic film, thus the manufacturing cost of the instant disclosure can be decreased.

Referring the following <Table 1>, Sample 1 to Sample 7 are different experiment samples with different additive formulas, and each sample shows its weight percentage of each additive formula. The label A is thermohardening resin, the label B is photo-curing multiple functional group oligomer, the label C is UV-curing multiple functional group reaction monomer, the label D is a cross-linking agent, the label E is organic-inorganic nano hybrid material, the label F is inorganic nano particles, the label G is initiator, and the label H is additive.

TABLE 1

| | A | B | C | D | E | F | G | H |
|---|---|---|---|---|---|---|---|---|
| Sample 1 | 70% | 15% | — | 15% | — | — | 1.8% | 3% |
| Sample 2 | 55% | 32.5% | — | 12.5% | — | — | 2.7% | 3% |
| Sample 3 | 40% | 50% | — | 10% | — | — | 3.6% | 3% |
| Sample 4 | 55% | 32.5% | — | 12.5% | 5% | — | 3.6% | 3.15% |
| Sample 5 | 55% | 32.5% | — | 12.5% | 10% | — | 3.6% | 3.3% |
| Sample 6 | 55% | 32.5% | 10% | 12.5% | 5% | — | 4.2% | 3.5% |
| Sample 7 | 55% | 32.5% | 10% | 12.5% | — | 5% | 4.2% | 3.5% |

Referring the following <Table 2>, Samples 1-7 respectively proceed the following seven different characteristic tests to obtain the following experiment data.

TABLE 2

| | | | | steel wool | RCA | Forming | |
|---|---|---|---|---|---|---|---|
| | Hardness | Adhesion | optical | wear-resistant | wear-resistant | ability | Elongation |
| Sample | test | test | test (Haze) | test (ΔHaze) | test (Cycles) | test | test |
| Sample 1 | H | 5B | 0.15 | 12.58 | <20cycles | excellent | 1.5X |
| Sample 2 | 2H | 5B | 0.12 | 10.75 | >30cycles | Good | 1.2X |
| Sample 3 | 3H | 5B | 0.14 | 9.12 | >50cycles | ordinary | 1.1X |
| Sample 4 | 2H | 5B | 0.15 | 0.22 | >30cycles | Good | 1.2X |
| Sample 5 | 2H | 5B | 0.16 | 0.19 | >30cycles | Good | 1.2X |
| Sample 6 | 2H | 5B | 0.17 | 0.05 | >100cycles | Good | 1.15X |
| Sample 7 | 2H | 5B | 1.97 | 0.16 | >100cycles | Good | 1.15X |

Therefore, the instant disclosure can obtain the following conclusions according to the above-mentioned experiment data in <Table 1> and <Table 2>:

1. Comparing samples 1 to 3, when the weight percentages of the thermohardening resin and the cross-linking agent are decreased gradually and the weight percentages of the photo-curing multiple functional group oligomer and the initiator are increased gradually, the data obtained by the hardness test is increased gradually from H to 3H, the data obtained by the steel wool wear-resistant test (ΔHaze) is decreased gradually from 12.58 to 9.12, the data obtained by the RCA wear-resistant test (Cycles) is increased gradually from 20 cycles to 50 cycles, the data obtained by the forming ability test is decreased gradually from excellent to ordinary, and the data obtained by the elongation test is decreased gradually from 1.5×(times) to 1.1×.

2. Comparing samples 2, 4 and 5, when the weight percentages of the organic-inorganic nano hybrid material is increased gradually, the data obtained by the steel wool wear-resistant test (ΔHaze) is substantially decreased gradually from 10.75 to 0.19. Hence, when the weight percentages of the organic-inorganic nano hybrid material is increased by 5%, the steel wool wear-resistant is increased effectively.

3. Comparing samples 4 and 6, when the weight percentages of the UV-curing multiple functional group reaction monomer is increased gradually from 0% to 10%, the data obtained by the RCA wear-resistant test (Cycles) is substantially increased gradually from 30 cycles to 100 cycles and the data obtained by the steel wool wear-resistant test (ΔHaze) is decreased gradually from 0.22 to 0.05. Hence, when the weight percentages of the UV-curing multiple functional group reaction monomer is increased, the RCA wear-resistant is substantially increased and the steel wool wear-resistant is decreased.

4. Comparing samples 6 and 7, when the inorganic nano particles are added to the sample 7, the steel wool wear-resistant is decreased from 0.05 to 0.19 and the data obtained by the optical test (Haze) is substantially increased from 0.17 to 1.97. Hence, when the inorganic nano particles are added to the instant disclosure, the degree of clearness of the plasticity plastic film would be decreased. In conclusion, the sample 6 has high hardness (2H), excellent steel wool wear-resistant and RCA wear-resistant and good forming extensibility.

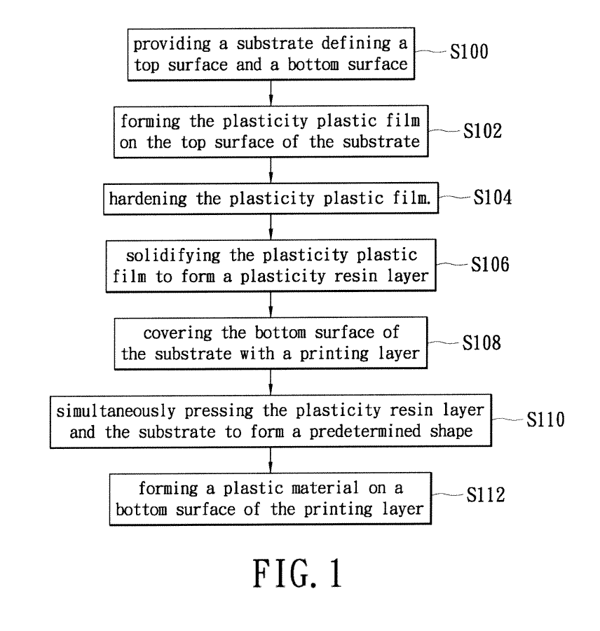

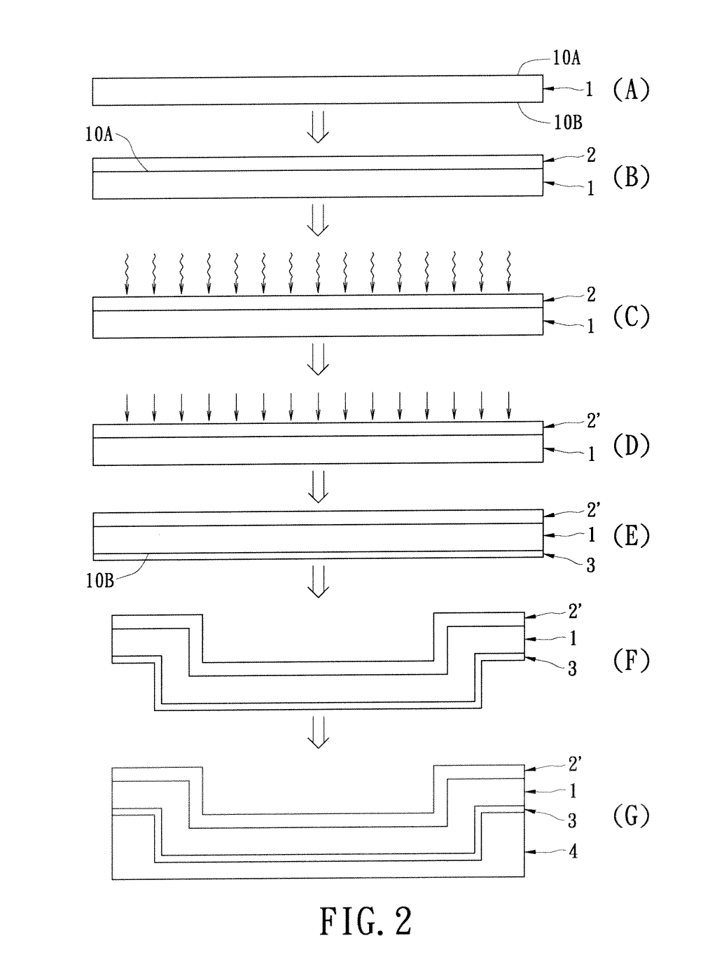

Referring to FIGS. 1 and 2, the instant disclosure provides a method for applying a plasticity plastic film to an in-mold decoration (IMD), including the following steps of:

The step 1 (S100): first, referring to FIGS. 1 and 2(A), providing a substrate 1 defining a top surface 10A and a bottom surface 10B. For example, the substrate 1 may be selected from the group consisting of polyethylene terephthalate (PET), polycarbonate (PC), tri-acetyl cellulose (TAC), polymethylmethacrylate (PMMA), methyl methacrylate styrene and cyclic olefin copolymer (COC), and the substrate has a thickness of between 10 μm and 1000 μm.

The step 2 (S102): referring to FIGS. 1 and 2(B), forming the plasticity plastic film 2 on the top surface 10A of the substrate 1. In addition, the plasticity plastic film 2 may include a photo-curing multiple functional group oligomer, a thermohardening resin and a cross-linking agent for cross-linking the photo-curing multiple functional group oligomer with the thermohardening resin as shown in the first and the second embodiments of the instant disclosure.

The step 3 (S104): referring to FIGS. 1 and 2(C), hardening the plasticity plastic film 2. For example, the plasticity plastic film 2 can be hardened by heating shown as the downward arrows in FIG. 2(C).

The step 4 (S106): referring to FIGS. 1 and 2(D), solidifying the plasticity plastic film 2 to form a plasticity resin layer 2′. For example, the plasticity plastic film 2 can be solidified to form the plasticity resin layer 2′ by UV light shown as the downward arrows in FIG. 2(D).

The step 5 (S108): referring to FIGS. 1 and 2(E), covering the bottom surface 10B of the substrate 1 with a printing layer 3.

The step 6 (S110): referring to FIGS. 1 and 2(F), simultaneously pressing the plasticity resin layer 2′ and the substrate 1 to form a predetermined shape. For example, the plasticity resin layer 2′, the substrate 1 and the printing layer 3 can be pressed simultaneously to form a predetermined shape as shown in FIG. 2(F) by high pressure molding or vacuum molding.

The step 7 (S112): finally, referring to FIGS. 1 and 2(G), forming a plastic material 4 on a bottom surface of the printing layer 3. For example, the plastic material 4 can be injected out and attached to the bottom surface of the printing layer 3 at the same time.

In conclusion, after the plasticity plastic film has been formed and solidified, the plasticity plastic film still has a certain plasticity, for example, the sample 6 has 2H hardness and 1.15× extensibility as shown in <Table 1>. However, the plastic film of the prior art only has 1.05×extensibility, thus the surface of the plastic film of the prior art would be cracked easily and the subsequent processing for the plastic film would be difficult. Therefore, the plasticity plastic film of the instant disclosure still can be formed as a predetermined shape by subsequent processing after solidifying the plasticity plastic film.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A plasticity plastic film consisting of:
a photo-curing multiple functional group oligomer represented by the following chemical formula: 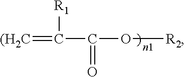
n1≧3, wherein R₁ is one of hydrogen (H) and alkyl (CH₃), and R₂ is one of alkyl, polyurethane, polyester, acrylate and epoxy resin;
a thermohardening resin being a chain type structure that is composed of a polyalcohol and an isocyanate, wherein the thermohardening resin is represented by the following chemical formula: —(—CONH—R—NHCO—O—R—O—)ₙ₂—, n2≧1 and R1 is alkyl; and
a cross-linking agent composed of a double-bond acrylic functional group structure and a hydroxyl group structure, wherein the cross-linking agent is represented by the following chemical formula: 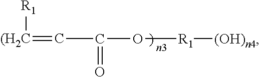
2≦n3+n4, 1≦n3 and 1≦n4;
wherein the photo-curing multiple functional group oligomer occupies 20%˜70% of the plasticity plastic film by weight, the thermohardening resin occupies 40%˜70% of the plasticity plastic film by weight, the cross-linking agent occupies 10%˜40% of the plasticity plastic film by weight, the double-bond acrylic functional group structure connects with the photo-curing multiple functional group oligomer, and the hydroxyl group structure connects with thermohardening resin.

2. The plasticity plastic film as claimed in claim 1, the composition of the plasticity plastic film further comprises a UV-curing multiple functional group reaction monomer, an organic-inorganic nano hybrid material, inorganic nano particles, an initiator and an additive.

3. The plasticity plastic film as claimed in claim 2, wherein the organic-inorganic nano hybrid material comprises a nano SiO₂ and a nano Al₂O₃, and the organic-inorganic nano hybrid material occupies 0.1%˜30% of the plasticity plastic film by weight.

4. The plasticity plastic film as claimed in claim 2, wherein the inorganic nano particles comprises nano SiO₂ powders and nano Al₂O₃ powders, and the inorganic nano particles occupy 0.1%˜30% of the plasticity plastic film by weight.

5. A plasticity plastic film, comprising:
a photo-curing multiple functional group oligomer represented by the following chemical formula: 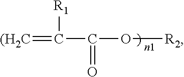
n1≧3, wherein R₁ is one of hydrogen (H) and alkyl (CH₃), and R₂ is one of alkyl, polyurethane, polyester, acrylate and epoxy resin;
a thermohardening resin being a chain type structure that is composed of a polyalcohol and an isocyanate, wherein the thermohardening resin is represented by the following chemical formula: —(—CONH—R—NHCO—O—R—O—)ₙ₂—, n2≧1 and R1 is alkyl; and
a cross-linking agent composed of a double-bond acrylic functional group structure and an isocyanate group structure, wherein the cross-linking agent is represented by the following chemical formula: 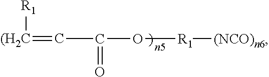
2≦n5+n6, 1≦n5 and 1≦n6;
wherein the photo-curing multiple functional group oligomer occupies 20%˜70% of the plasticity plastic film by weight, the thermohardening resin occupies 40%˜70% of the plasticity plastic film by weight, the cross-linking agent occupies 10%˜40% of the plasticity plastic film by weight, the double-bond acrylic functional group structure connects with the photo-curing multiple functional group oligomer, and the isocyanate group structure connects with thermohardening resin.

6. A method for applying a plasticity plastic film to an in-mold decoration, comprising the steps of:
(a) providing a substrate defining a top surface and a bottom surface, printing layer and a plastic material, wherein the plasticity plastic film comprises a photo-curing multiple functional group oligomer, a thermohardening resin and a cross-linking agent, and the photo-curing multiple functional group oligomer is cross-linked with the thermohardening resin through the cross-linking agent;
(b) forming the plasticity plastic film on the top surface of the substrate;
(c) hardening the plasticity plastic film;
(d) solidifying the plasticity plastic film to form a plasticity resin layer;
(e) covering the bottom surface of the substrate with the printing layer;
(f) simultaneously pressing the plasticity resin layer and the substrate to form a predetermined shape; and
(g) forming the plastic material on a bottom surface of the printing layer.

7. The method as claimed in claim 6, wherein the step (f) is finished by high pressure molding or vacuum molding.

8. The method as claimed in claim 6, wherein the step (g) is finished by injection molding.

9. The method as claimed in claim 6, wherein the substrate is selected from the group consisting of polyethylene terephthalate, polycarbonate, tri-acetyl cellulose, polymethylmethacrylate, methyl methacrylate styrene and cyclic olefin copolymer, and the substrate has a thickness of between 10 μm and 1000 μm.
